(19) United States
(12) Patent Application Publication
(10) Pub. No.: US 2017/0237113 A1
(43) Pub. Date: Aug. 17, 2017

(54) RECEPTACLE FOR A BATTERY MODULE, AND BATTERY MODULE HAVING A RECEPTACLE OF THIS KIND

(71) Applicant: Robert Bosch GmbH, Stuttgart (DE)

(72) Inventors: Andreas Ruehle, Bietigheim-Bissingen (DE); Carsten Mueller, Stuttgart (DE); Eduard Reimer, Stuttgart (DE); Ralf Angerbauer, Moeglingen (DE); Stefan Baumann, Altenriet (DE); Maximilian Russ-Mohl, Stuttgart (DE)

(21) Appl. No.: 15/504,377

(22) PCT Filed: Aug. 3, 2015
(86) PCT No.: PCT/EP2015/067779

§ 371 Date: Feb. 16, 2017

(30) Foreign Application Priority Data
Aug. 19, 2014 (DE) 10 2014 216 407.9

(51) Int. Cl. H01M 10/04; H01M 2/10

(52) U.S. Cl. CPC H01M 10/0481; H01M 2/1077; H01M 2220/20

(57) ABSTRACT

The present invention relates to a receptacle (10) for accommodating at least one battery cell (12) for a battery module such that said battery cell is at least partially pressed in, wherein the receptacle (10) has two end plates (14ₐ, 14_{b}) which can be arranged on two opposite sides of the at least one battery cell (12), characterized in that the end plates (14ₐ, 14_{b}) are connected by a plurality of rod-like supports (16_{a-d}) which are fixed to the end plates (14ₐ, 14_{b}), wherein the supports (16_{a-d}) are designed to support in each case one edge (18_{a-d}) of the at least one battery cell (12) in two dimensions. In summary, a receptacle (10) of the kind described above, in a particularly simple and cost-effective manner, allows battery cells (12) to be fixed in a battery module and allows the performance of a battery module to be maintained, irrespective of the temperature, by at least temporary bracing.

### BACKGROUND OF THE INVENTION

The present invention relates to a receptacle for a battery module, in particular for fixing and possibly compressing at least one battery cell. The present invention also relates to a battery module having a receptacle of said type, wherein at least one battery cell is arranged in the receptacle.

Electrochemical energy stores, such as for example lithium-ion batteries, are widely used in numerous day-to-day applications. They are used for example in computers, such as for example laptops, mobile telephones, smartphones and in other applications. Such batteries also offer advantages in the nowadays greatly advanced electrification of vehicles, such as for example motor vehicles, for example in the case of electric vehicles or hybrid vehicles.

Lithium-ion batteries, for example for the automotive sector, often comprise a multiplicity of individual battery cells. In order to increase the voltage or current level, said cells are interconnected in parallel or in series and are mechanically combined to form modules. Here, the cells often comprise a metallic housing in which the cell unit, for example comprising electrodes in a wound configuration, are situated.

The cell units arranged in the housings may often swell up or expand in the event of a temperature increase or owing to a charging or discharging process. As a result, the internal resistance of the cell increases, and the power thereof decreases. It is therefore known for a force to be externally applied to the module by way of a tension strap in order to thus press the cells together and prevent the swelling. It is alternatively known for the battery cells to be surrounded by a frame which counteracts a cell expansion. Such frames are often composed of welded components or likewise have tension straps.

Document DE 10 2010 046 529 A1 has disclosed a tetragonal frame system for accommodating at least one battery cell. A frame system of said type has two pressure plates and two side parts, wherein the two side parts are fixed to the two pressure plates.

Document U.S. Pat. No. 8,586,235 has furthermore disclosed a battery module which has a multiplicity of battery cells. Here, end plates equipped with reinforcement means are provided on two end regions of the multiplicity of battery cells, wherein the end plates are connected to one another by connecting means.

Document D3 furthermore describes a high-voltage battery with a number of cell blocks, wherein each cell block has a number of cells. Here, the cells are arranged on a cooling plate and are furthermore surrounded by an arrangement having pressure frames and fastening means connecting said pressure frames.

Document U.S. Pat. No. 8,163,420 furthermore describes a battery system having a battery block which has a multiplicity of battery cells which are arranged in a stacked manner together with insulators. Here, the battery block is held by fastening means which have end plates and metal straps connecting said end plates.

Document US 2013/0288105 A1 has furthermore disclosed a battery module having a multiplicity of battery cells, wherein end plates or side plates are provided on corresponding side of the multiplicity of battery cells. Here, the side plates and the end plates are fastened to one another, whereby the battery cells are bound together.

### SUMMARY OF THE INVENTION

The present invention relates to a receptacle for accommodating, at least partially with a compressive action, at least one battery cell for a battery module, wherein the receptacle has two end plates which can be arranged on two opposite sides of the at least one battery cell, wherein the end plates are connected by way of a multiplicity of rod-like supports which are fixed to the end plates, wherein the supports are designed for the at least two-dimensional support of in each case one edge of the at least one battery cell.

A receptacle of said type makes it possible in particular to realize a lightweight and inexpensive receptacle for forming a battery module, by way of which receptacle a deterioration of the power of the battery module as a result of an expansion or swelling of the battery cell or of the battery cells can be prevented.

The above-described receptacle thus serves in particular for accommodating, at least partially with a compressive action, at least one battery cell. In particular, the receptacle may serve for accommodating a multiplicity of battery cells which, by way of corresponding interconnection with one another, in particular together with the receptacle, form a battery module. The accommodation of the battery cell or of the battery cells is thus to be understood to mean that the battery cell or the battery cells are arranged in the receptacle or are at least partially surrounded by the receptacle. Furthermore, the accommodation at least partially with a compressive action is to be understood to mean that the at least one battery cell does not need to be permanently compressed, but rather may be compressed only in an operational state of the battery cell, for example in an operational state in which an expansion of the at least one battery cell occurs. Thus, for example, a partial compression may mean a temporary compression.

The receptacle has two end plates which can be arranged on two opposite sides of the at least one battery cell. It is thus possible for a battery cell to be arranged between the end plates, or a multiplicity of battery cells may be arranged between the end plates without each battery cell having to be in direct contact with one or with both end plates. Here, if a multiplicity of battery cells are provided, the end plates may in particular be arranged so as to be present in each case on the end of an arrangement or of a stack of the battery cells, and so as to be in contact for example with the corresponding outer battery cells. It is thus then possible for in each case one end plate to be arranged in front of the first and behind the last battery cell. The end plates may in this case be configured or dimensioned such that they can support the entire battery cell or the entire side, bearing against the end plate, of the battery cell.

It is thus possible for the end plates to perform in particular the task of a pressure plate in order to thereby permit at least partial or temporary bracing of the at least one battery cell. Such bracing may serve in particular for counteracting a for example temperature-induced swelling of the battery cells, whereby the internal resistance of the cell is increased and the power thereof decreases. Swelling may in this case be caused for example by an evaporation of electrolytes contained in the cell, or else by charging or discharging processes.

In the case of a receptacle as described above, it is furthermore provided that the end plates are connected by way of a multiplicity of rod-like supports which are fixed to the end plates. In other words, the receptacle comprises a multiplicity of supports which are fixed to the end plates and which thus connect these. In this way, the receptacle can form a stable and self-supporting structure.

Here, the supports are of rod-like form, which in the context of the present invention is intended in particular to mean that the supports have a smaller and thus only limited width in relation to their length running between the end plates, and thus the individual supports are spaced apart from one another. In particular, a rod-like support is to be understood to mean that such a support is present only in a limited region of the receptacle, and for example does not form an entire side surface but rather is present for example only in a corner region of the receptacle.

By virtue of the fact that the supports are of rod-like form, it is possible for a very stable support to be combined with a particularly lightweight support. This is because, owing to the only limited spatial extent, the supports have only a limited material requirement, such that weight can be saved. This is advantageous in particular for mobile applications, for example in the case of use in an at least partially electrically driven vehicle.

Furthermore, by way of a material saving and also a reduction or simplification of components that is achieved in relation to solutions from the prior art, a particularly inexpensive embodiment can be made possible.

Furthermore, particularly good stability can be realized, because forces acting externally on the receptacle can be dissipated in an effective manner by way of a frame of in particular rigidly connected parts which is formed by the receptacle.

To support the battery cell or the battery cells, it is provided here, with regard to the supports, that these are designed for the at least two-dimensional support of in each case one edge of the at least one battery cell. In other words, the supports are designed such that the edges of a battery cell, in particular in the case of plate-like battery cells, are supported in two dimensions or in two planes. Here, the dimensions or planes in which support is to be realized are arranged in particular at right angles to the support provided by the end plates. Thus, three-dimensional and thus complete support of the battery cells can jointly be made possible by way of an interaction of the supports and the end plates.

In this way, the battery cell or the battery cells are securely fixed in all spatial directions. It is thus possible to eliminate the need for a defined preload to be provided already in a normal state of the battery cells, that is to say in a state without expansion. This makes it possible for the battery cells to be conserved, and thus permits particularly advantageous durability of the battery cells and thus of the battery module. In other words, the disadvantage of the solutions from the prior art, whereby the module base was often of open design and battery cells were thus able to become detached from the assembly in the absence of a preload, can be circumvented. It is however pointed out that the provision of a preload even in a normal state is duly not necessary, but is also not ruled out, in the context of the present invention.

Here, a rod-like form of the supports is not disadvantageous because the battery cells undergo state-of-charge-dependent or temperature-dependent bulging often only in the dimension of the support of the end plates. Thus, support over the full area by way of the end plates may be sufficient for the prevention or counteraction of an expansion of the battery cells.

Furthermore, the described receptacle is basically suitable for a wide variety of embodiments of battery cells. It is thus for example possible for bulged or convex cells, and also concave cells, to be used, wherein a minimum compression force is basically not necessary for all of the cells.

Furthermore, a receptacle of said type may be produced for example through the use of for example standardized profiles, available as standard, which can be connected in positively locking or cohesive fashion to the end plates, for example with the aid of bushings described below. Here, it is possible to dispense with a laser welding process, which can be cumbersome and highly complex owing to relatively large tolerance chains.

In summary, a receptacle as described above makes it possible in a particularly simple and inexpensive manner for battery cells to be fixed in a battery module and for the performance of a battery module to be maintained in a temperature-independent manner by way of an at least temporary bracing action.

In one embodiment, four supports may be provided which, together with the end plates, define a cuboid. In other words, the end plates may define in each case oppositely arranged sides of the cuboid, wherein the edges that connect said sides are formed by the supports. In this embodiment, the receptacle can be particularly advantageously suitable for the use of substantially rectangular battery cells, wherein the respective edges of the battery cells can be fixed by way of the supports. Here, depending on the design and number of the battery cells, the cuboid may be of square or rectangular shape.

In the context of a further embodiment, the supports may have two limbs which are arranged substantially at right angles with respect to one another. In this embodiment, particularly simple and inexpensive producibility can be combined with secure and fixed support of the corresponding battery cells or of the edges thereof. Here, the supports may in each case in a particularly simple manner be of unipartite form and formed for example by a bent, originally planar rod-like component. Here, the limbs need merely have a small width in order to thereby form a desired support with a suitable thickness. Here, an orientation substantially at right angles is intended to mean an exactly right angle or an angle which may have a deviation of +/−15°, in particular +/−5°, from a right angle.

In the context of a further embodiment, the supports may be formed from a metallic material. For example, the supports may be formed from steel. In this embodiment, it is possible for a particularly high level of stability of the receptacle to be realized. Here, the receptacle may furthermore, despite the metallic embodiment of the supports, have a low weight owing to its rod-like design, because only a relatively small amount of material needs to be used for the supports.

In the context of a further embodiment, the end plates may be formed from a plastic. Through the use of a plastic, the receptacle can be particularly lightweight, which may be advantageous in particular for mobile applications, for example for at least partially electrically driven vehicles. Furthermore, by way of plastics plates, it is also possible for adequate stability to be realized, such that secure bracing or fixing of the battery cells is possible.

In a further embodiment, the end plates may at least partially have a honeycomb-like structure. In particular through the provision of a honeycomb-like structure, the end plates can have a particularly low weight and nevertheless high stability. Here, a honeycomb-like structure may be understood in particular to mean a structure which has mutually immediately adjacent recesses of hexagonal form. Here, the hexagonal recesses are delimited for example by frames which, with the exception of the outer frames, are assigned in each case to two hexagonal recesses. Here, such structures may be provided in particular on a surface which is provided for being arranged on the side situated opposite the battery cell.

In the context of a further embodiment, the supports may be fixed to the end plates by way of fixing means running substantially at right angles to the direction of extent of said supports. In this embodiment, it is thus possible for fixing means, such as for example screws, bolts or the like, to be provided which for example run through the end plates or are fastened thereto and, here, have a direction of extent which runs substantially at right angles to the direction of extent of the supports. The direction of extent of the supports is in this case intended in particular to mean the length thereof, and thus the direction from one end plate to the further end plate. Thus, in a finished module, the fixing means run approximately in a direction which runs from the top side of the battery cells to the bottom side thereof. Here, an orientation substantially at right angles is intended to mean an exactly right angle or an angle which may have a deviation of +/−15°, in particular +/−5°, from a right angle. In this embodiment, particularly stable fixing of end plates and supports may be realized.

In a further preferred embodiment, the end plates may have in each case at least two bushings which run substantially at right angles to the direction of extent of the supports. Here, the bushings serve in particular for serving as fixing means themselves, or for receiving or interacting with a fixing means. Thus, in this embodiment, it may be provided that the bushings are fixed to the end plate or advantageously run through the end plate. In particular, in this embodiment, the arrangement can be particularly stable because forces introduced externally can be reliably absorbed. Here, it is possible in particular for two bushings to be provided, such that, on each side of the end plate, there can be accommodated a fixing means which can fix in each case an upper and a lower support to the end plate.

Here, it may furthermore be provided that the bushing is composed of a metallic material, that is to say of a material which has a metal, for example of steel. This embodiment may be advantageous in particular if the end plates are formed from a plastic. As a result of the bushing being formed from metal, it is possible for an introduction of force into the material of the end plates themselves to be reduced, whereby damage to the end plates can be prevented, or at least significantly reduced, even under the action of relatively high forces.

With regard to further technical features and advantages of the receptacle according to the invention, reference is hereby explicitly made to the explanations regarding the battery module according to the invention, the figures and the description of the figures.

The present invention also relates to a battery module having at least one battery cell, in particular having a multiplicity of battery cells, wherein the battery module has at least one receptacle for accommodating the at least one battery cell.

In summary, a battery module as described above makes it possible in a particularly simple and inexpensive manner for battery cells to be fixed and, by way of an at least temporary bracing action, for the performance of the battery cells and thus of the battery module to be maintained in a temperature-independent manner.

With regard to further technical features and advantages of the battery module according to the invention, reference is hereby explicitly made to the explanations regarding the receptacle according to the invention, the figures and the description of the figures.

### BRIEF DESCRIPTION OF THE DRAWINGS

Further advantages and advantageous embodiments of the subjects according to the invention will be illustrated by the drawings and discussed in the description below, wherein the describing features may constitute a subject matter of the present invention individually or in any desired combination, unless clearly indicated otherwise by the context. Here, it must be observed that the drawings are merely of a descriptive nature and are not intended to restrict the invention in any form. In the drawings:

FIG. 1 shows a schematic view of an embodiment of a receptacle as per an embodiment of the invention;

FIG. 2 shows a schematic view of a receptacle as per FIG. 1 with battery cells arranged therein;

FIG. 3 shows a schematic view of a battery cell for arrangement in a receptacle according to the invention;

FIG. 4 shows a schematic view of an end plate for a receptacle as per an embodiment of the invention;

FIG. 5 shows a further schematic view of the end plate from FIG. 4;

FIG. 6 shows a schematic sectional view of an end plate for a receptacle according to the invention;

FIG. 7 shows a schematic sectional view of a part of an end plate with a support, fixed thereto, for a receptacle according to an embodiment of the present invention;

FIG. 8 shows a schematic sectional view of a part of an end plate with a support, fixed thereto, for a receptacle according to a further embodiment of the present invention;

FIG. 9 shows a schematic sectional view of a part of an end plate with a support, fixed thereto, for a receptacle according to a further embodiment of the present invention;

FIG. 10 shows a schematic sectional view of a part of an end plate with a support, fixed thereto, for a receptacle according to a further embodiment of the present invention;

FIG. 11 shows a schematic sectional view of a part of an end plate with a support, fixed thereto, for a receptacle according to a further embodiment of the present invention;

FIG. 12 shows a schematic sectional view of a part of an end plate with a support, fixed thereto, for a receptacle according to a further embodiment of the present invention;

FIG. 13 shows a schematic sectional view of a part of an end plate with a support, fixed thereto, for a receptacle according to a further embodiment of the present invention;

FIG. 14 shows a schematic sectional view of a part of an end plate with a support, fixed thereto, for a receptacle according to a further embodiment of the present invention.

### DETAILED DESCRIPTION

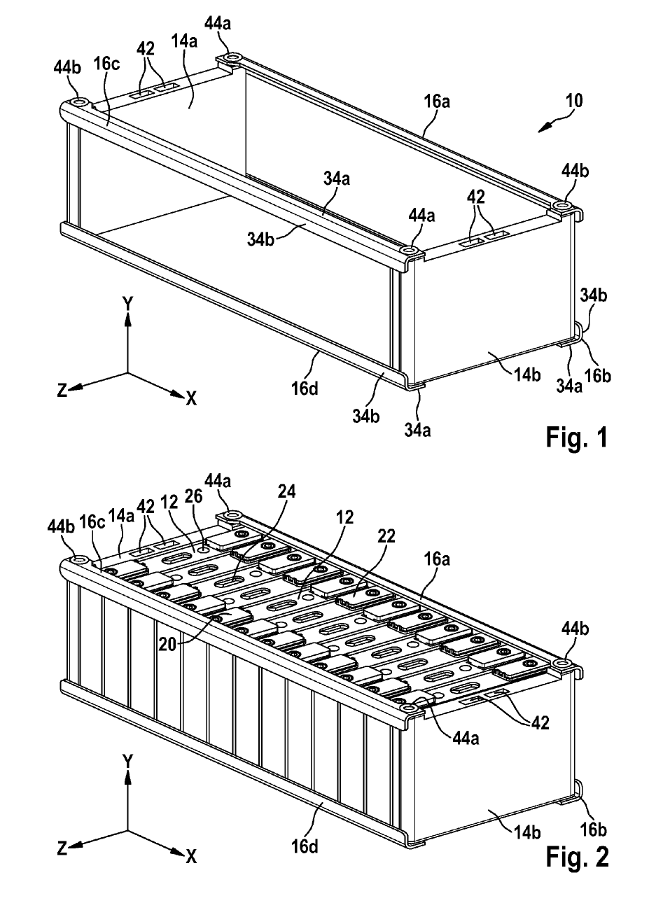

FIG. 1 shows a receptacle 10 for accommodating, at least partially with a compressive action, at least one battery cell 12 for a battery module. Here, the receptacle in FIG. 1 is designed for accommodating a multiplicity of battery cells 12, as shown in detail in FIG. 2, where a multiplicity of battery cells 12 are arranged in the receptacle 10.

The receptacle has two end plates 14ₐ, 14_{b} which can be arranged on two opposite sides of the at least one battery cell 12. The end plates 14ₐ, 14_{b} may be formed for example from a plastic. In the embodiment as per FIGS. 1 and 2, the end plates 14ₐ, 14_{b} are or can be arranged in each case in front of a first and behind a last battery cell 12 of a stack of battery cells 12.

It is also shown that the end plates 14ₐ, 14_{b} are connected by way of a multiplicity of rod-like supports 16_{a-d} which are fixed to the end plates 14ₐ, 14_{b}, wherein the supports 16_{a-d} are designed for the at least two-dimensional support of in each case one edge 18_{a-d} of the at least one battery cell 12. In detail, it is shown that four supports 16_{a-d} are provided, which together with the end plates 14ₐ, 14_{b} define a cuboid. The supports 16_{a-d} may be formed for example from a metallic material, for example from steel.

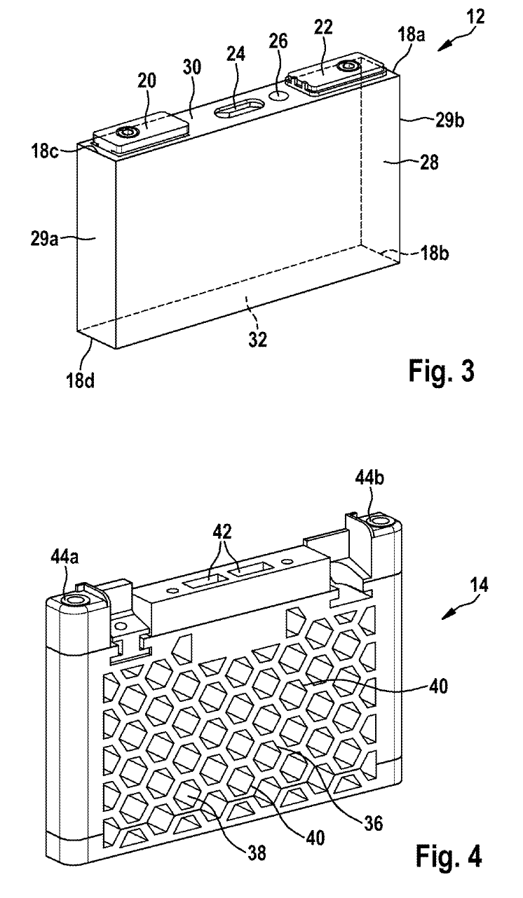

An above-described edge 18_{a-d} of a battery cell 12 is schematically shown in FIG. 3. Said figure shows a substantially rectangular battery cell 12 which has in each case a positive contact 20, a negative contact 22, a ruptured diaphragm 24 and a closure 26 of the battery housing 28. Here, the edges 18_{a-d} form in each case a delimitation of the mutually opposite side surfaces 29ₐ, 29_{b} with respect to the top side 30 and the bottom side 32 respectively.

Here, FIGS. 1 and 2 also show a coordinate system illustrating three-dimensional support of the battery cells 12. In detail, in terms of the coordinate system in FIGS. 1 and 2, support in the x plane is realized by way of the end plates 14ₐ, 14_{b} and support in the y direction and z direction is realized by way of the supports 16_{a-d}.

In detail, it is provided for this purpose that the supports 16_{a-d} have two limbs 34ₐ, 34_{b} which are arranged substantially at right angles with respect to one another. Here, the limb 34ₐ acts so as to provide support in the y plane, and the limb 34_{b} arranged substantially at right angles to the limb 34ₐ acts so as to provide support in the z plane.

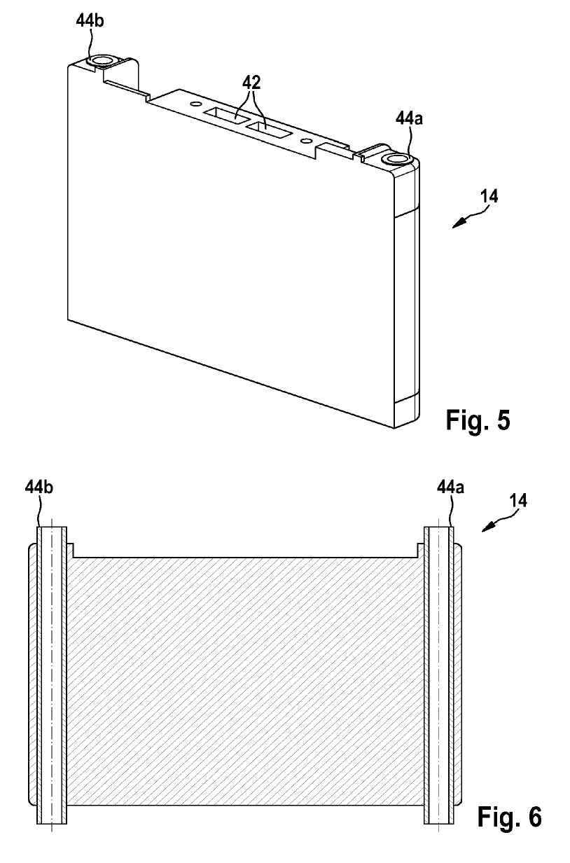

With regard to the end plates 14ₐ, 14_{b}, it is also shown in FIGS. 4 and 5 that these have at least partially honeycomb-like structures 36. Here, the structures 36 may be formed for example by hexagonal recesses 38 which, at their borders or frames 40, are arranged adjacently so as to yield a honeycomb pattern, which may extend substantially over the entire surface. The end plates 14ₐ, 14_{b} may be formed for example from a plastic, and configured for example as injection-molded parts.

Furthermore, the end plates 14ₐ, 14_{b}, also referred to as adapter plates, may have recesses 42 in order that, during the course of manufacture or during repair work, the receptacle 10 or the module can be gripped and handled by way of a suitable tool.

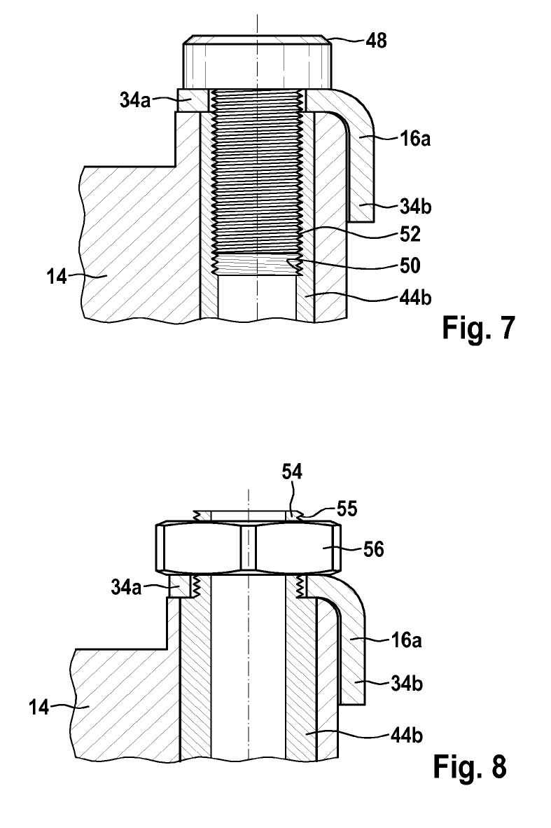

FIGS. 4 to 6 also show that the end plates 14 have in each case at least two bushings 44ₐ, 44_{b} which run substantially at right angles to the direction of extent of the supports 16_{a-d}, which bushings are formed for example from a metallic material. The bushings 44ₐ, 44_{b} may for example be injection-molded or pressed into the end plates 14ₐ, 14_{b}. By way of the bushings 44ₐ, 44_{b}, it can be made possible for the supports 16_{a-d} to be fixed to the end plates 14ₐ, 14_{b} by way of fixing means 46 running substantially at right angles to the direction of extent of the supports 16_{a-d}, wherein the fixing means are formed by the bushings 44ₐ, 44_{b} or can be received by the bushings 44ₐ, 44_{b}. Various embodiments of the fixings are shown in FIGS. 7 to 14, wherein said embodiments basically apply to all bushings 44 or end plates 14 that are provided. Here, the connecting technology may be adapted in a manner dependent on the number of battery cells 12. For example, in the case of a small number of battery cells 12, a non-positively locking connection may be sufficient, whereas a positively locking or cohesive connection may be advantageous in the case of relatively large numbers.

In detail, FIG. 7 shows that a screw 48 is used as fixing means. This may be advantageous in particular if the bushing 44_{b} has an internal thread 50 into which the thread 52 of the screw 48 can engage.

FIG. 8 shows an embodiment in which a hollow shaft 54 is arranged in the bushing 44_{b}, or in which the bushing forms the hollow shaft, which hollow shaft has an external thread 55 into which, on one side or both sides, a nut 56 can engage in order to thereby fix the supports 16ₐ. Here, the hollow shaft 54 may serve as fixing means.

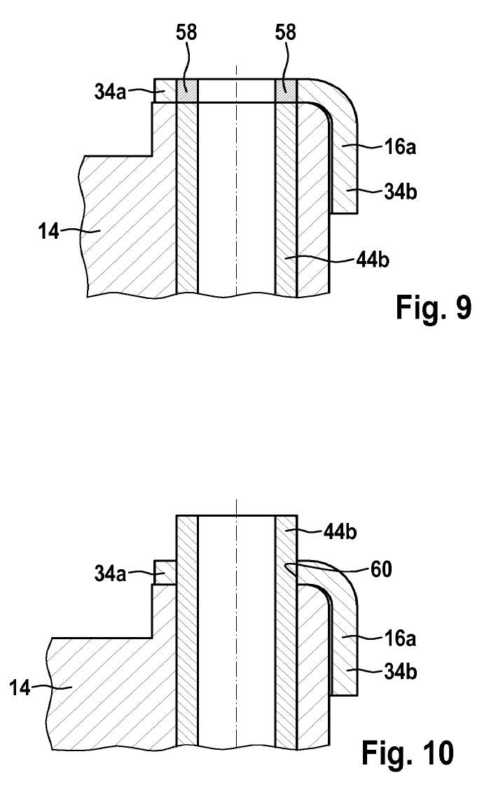

In FIG. 9, it is shown that the support 16ₐ is welded for example at two weld points 58 to the end plate 14 and/or to the bushing 44_{b}.

FIG. 10 furthermore shows that the bushing 44_{b} is pressed into an opening 60 of the support 16ₐ, or that the support 16ₐ is shrink-fitted onto the bushing 44_{b}.

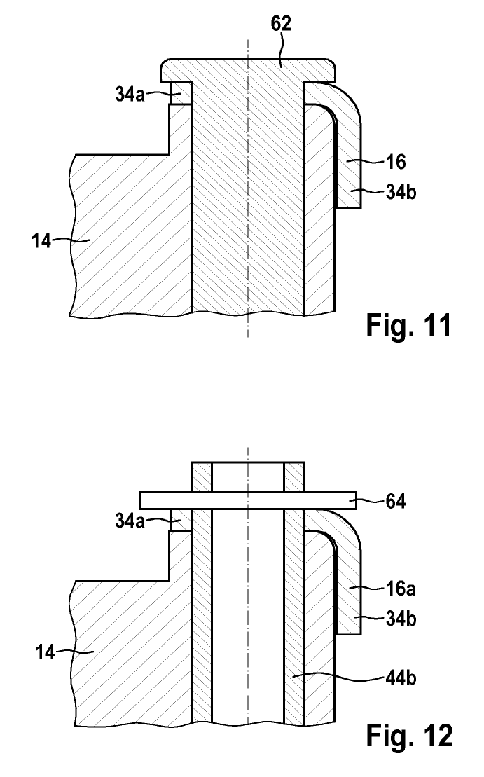

FIG. 11 shows an embodiment in which the support 16ₐ is fixed by way of a rivet 62 guided into the end plate 14. Here, no bushing 44 needs to be provided.

An embodiment in which the support 16ₐ is fixed to the bushing 44_{b} by way of a splint 64 is shown in FIG. 12.

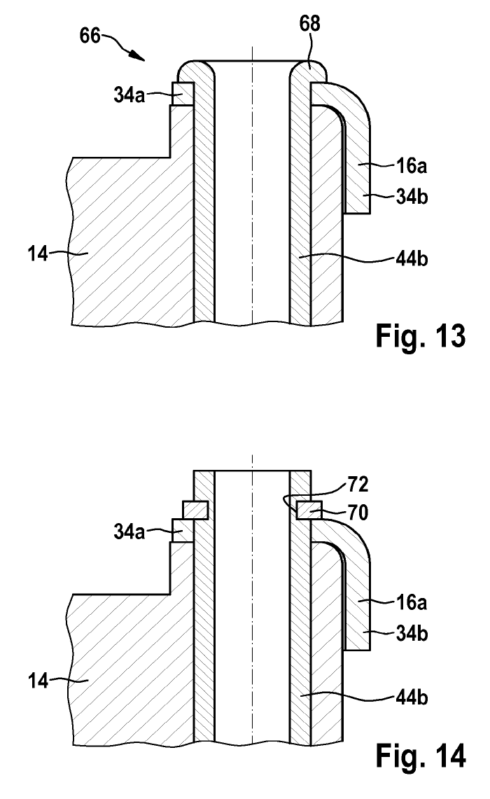

FIG. 13 furthermore shows that the bushing 44_{b} is deformed at its end region 66 so as to form a fixing region 68 in order to thereby fix the support 16ₐ on the bushing 44_{b}. Here, a deformation may be realizable for example by flanging or folding.

A further embodiment is shown in FIG. 14 in which a securing element 70, such as for example a circlip, for example a shaft circlip, engages into a recess 72 of the bushing 44_{b}, in order thereby to fix the support 16ₐ on the bushing 44_{b}.

Here, the above-described fixing means may be used individually or in any desired combination in order to thus fix the different supports 16_{a-d} or the different ends thereof to the corresponding end plates 14ₐ, 14_{b}, for example to the bushings 44ₐ, 44_{b}.

1. A receptacle (10) for accommodating, at least partially with a compressive action, at least one battery cell (12) for a battery module, wherein the receptacle (10) has two end plates (14ₐ, 14_{b}) configured to be arranged on two opposite sides of the at least one battery cell (12), characterized in that the end plates (14ₐ, 14_{b}) are connected by a multiplicity of rod-like supports (16_{a-d}) which are fixed to the end plates (14ₐ, 14_{b}), wherein the supports (16_{a-d}) are configured to provide at least two-dimensional support of in each case one edge (18_{a-d}) of the at least one battery cell (12).

2. The receptacle (10) as claimed in claim 1, characterized in that the multiplicity of rod-like supports includes four supports (16_{a-d}) which, together with the end plates (14ₐ, 14_{b}), define a cuboid.

3. The receptacle (10) as claimed in claim 1, characterized in that the supports (16_{a-d}) each have two limbs (34ₐ, 34_{b}) which are arranged substantially at right angles with respect to one another.

4. The receptacle (10) as claimed in claim 1, characterized in that the supports (16_{a-d}) are formed from a metallic material.

5. The receptacle (10) as claimed in claim , characterized in that the end plates (14ₐ, 14_{b}) are formed from a plastic.

6. The receptacle (10) as claimed in claim 1, characterized in that the end plates (14ₐ, 14_{b}) at least partially have a honeycomb-like structure (36).

7. The receptacle (10) as claimed in claim 1, characterized in that the supports (16_{a-d}) are fixed to the end plates (14ₐ, 14_{b}) by fixing means running substantially at right angles to a direction of extent of said supports.

8. The receptacle (10) as claimed in 1, characterized in that the end plates (14ₐ, 14_{b}) have in each case at least two bushings (44ₐ, 44_{b}) which run substantially at right angles to a direction of extent of the supports (16_{a-d}).

9. The receptacle (10) as claimed in claim 8, characterized in that the bushings (44ₐ, 44_{b}) are formed from a metallic material.

10. A battery module having at least one battery cell (12), characterized in that the battery module has at least one receptacle (10) for accommodating the at least one battery cell (12).

11. The battery module as claimed in claim 10, wherein the receptacle accommodates, at least partially with a compressive action, the at least one battery cell (12), wherein the receptacle (10) has two end plates (14ₐ, 14_{b}) configured to be arranged on two opposite sides of the at least one battery cell (12), and wherein the end plates (14ₐ, 14_{b}) are connected by a multiplicity of rod-like supports (16_{a-d}) which are fixed to the end plates (14ₐ, 14_{b}), wherein the supports (16_{a-d}) are configured to provide at least two-dimensional support of in each case one edge (18_{a-d}) of the at least one battery cell (12).

12. The battery module as claimed in claim 11, characterized in that the multiplicity of rod-like supports includes four supports (16_{a-d}) which, together with the end plates (14ₐ, 14_{b}), define a cuboid.

13. The battery module as claimed in claim 11, characterized in that the supports (16_{a-d}) each have two limbs (34ₐ, 34_{b}) which are arranged substantially at right angles with respect to one another.

14. The battery module as claimed in claim 11, characterized in that the supports (16_{a-d}) are formed from a metallic material.

15. The battery module as claimed in claim 11, characterized in that the end plates (14ₐ, 14_{b}) are formed from a plastic.

16. The battery module as claimed in claim 11, characterized in that the end plates (14ₐ, 14_{b}) at least partially have a honeycomb-like structure (36).

17. The battery module as claimed in claim 11, characterized in that the supports (16_{a-d}) are fixed to the end plates (14ₐ, 14_{b}) by fixing means running substantially at right angles to a direction of extent of said supports.

18. The battery module as claimed in claim 11, characterized in that the end plates (14ₐ, 14_{b}) have in each case at least two bushings (44ₐ, 44_{b}) which run substantially at right angles to a direction of extent of the supports (16_{a-d}).

19. The battery module as claimed in claim 18, characterized in that the bushings (44ₐ, 44_{b}) are formed from a metallic material.
